(19) United States
(12) Patent Application Publication
(10) Pub. No.: US 2002/0069252 A1
(43) Pub. Date: Jun. 6, 2002

(54) Personal multimedia device and methods of use thereof

(75) Inventors: Ronald L. Jones, Palo Alto, CA (US); Michael K. Collins, Cupertino, CA (US)

Correspondence Address: BEYER WEAVER & THOMAS LLP, P.O. BOX 778, BERKELEY, CA, 94704-0778, US

(73) Assignee: Songpro.com, Inc.

(21) Appl. No.: 09/903,220

(22) Filed: Jul. 10, 2001

Related U.S. Application Data
(60) Provisional application No. 60/217,225, filed on Jul. 10, 2000.
(60) Provisional application No. 60/217,184, filed on Jul. 10, 2000.

(51) Int. Cl. G06F 15/16

(52) U.S. Cl. 709/206; 709/208

(57) ABSTRACT

A personal multi-media device (PMD) and methods of use thereof is disclosed. The PMD includes a controller portion having a host processor, a keypad connected to the host processor arranged to receive a user supplied command, and a display unit arranged to display an image, or a series of correlated images, derived from a multi-media content file stored in a multi-media card connected to the personal multi-media device. The PMD also includes a cartridge portion connected to the controller portion by way of a multi-media content address/data bus having a slave processor arranged to decode the multi-media content file as directed by the host processor, and a mailbox coupling the slave processor to the host processor arranged as an addressable latch configured to provide an information channel between the host processor and the slave processor.

### CROSS REFERENCE TO RELATED APPLICATIONS

This application claims benefit of priority under 35 U.S.C. 119(e) of (i) U.S. U.S. Provisional Application No. 60/217,225, filed Jul. 10, 2000 and entitled “Methods and Apparatus for Delivering Digital Multi-Media Content in a Vending Machine Environment” by Ron Jones, and (ii) U.S. Provisional Application No. 60/217,184, filed Jul. 10, 2000 and entitled “Personal Multi-Media Device” by Ron Jones each of which is hereby incorporated by reference in their entirety for all purposes. This application is also related to Patent Application Serial No. ______ entitled “METHOD AND APPARATUS FOR DELIVERING DIGITAL MULTIMEDIA CONTENT” by Jones et. al. which is filed concurrently herewith and incorporated by reference in its entirety.

### BACKGROUND OF THE INVENTION

1. Technical Field

This invention relates generally to digital multimedia content and distribution thereof. More specifically, a personal multi-media device useful for disseminating digital multimedia content at a personal level are disclosed.

2. Description of the Related Art

The current explosion of digital multimedia content, such as digitally encoded music, video, etc. has been limited to distribution channels that include a server computer linked to a client side computer, such as a personal computer (either desk top or laptop) or other client side information devices such as personal digital assistants (PDAs). A major limitation of these digital multimedia distribution channels is the requirement that a user be connected to the server computer, usually by way of the Internet in either a wire or wireless mode. This has several disadvantages in those situations where the user does not have the capability, nor the resources, to connect to the server computer. Such situations arise, for example, when the user is waiting in a bus or air terminal where all that is available is a personal multimedia processing device (such as an MP3 type player) that, although capable of receiving appropriately decoded multimedia content (such as audio and/or audio/video), is not able to receive such content due to the lack of a connection to the Internet.

Therefore what is desired is a configurable and portable personal player capable of playing any number and type of digital multi-media content.

### SUMMARY OF THE INVENTION

A personal multi-media device (PMD) and methods of use thereof are disclosed. In one aspect of the invention, the PMD includes a controller portion having a host processor, a keypad connected to the host processor arranged to receive a user supplied command, and a display unit arranged to display an image, or a series of correlated images, derived from a multi-media content file stored in a multi-media card connected to the personal multi-media device. The PMD also includes a cartridge portion connected to the controller portion by way of a multi-media content address/data bus having a slave processor arranged to decode the multi-media content file as directed by the host processor, and a mailbox coupling the slave processor to the host processor arranged as an addressable latch configured to provide an information channel between the host processor and the slave processor.

In another embodiment, a method of providing a personal multi-media device is disclosed. The method includes the operations of providing a controller portion having a host processor, a keypad connected to the host processor arranged to receive a user supplied command, and a display unit arranged to display an image, or a series of correlated images, derived from a multi-media content file stored in a multi-media card connected to the personal multi-media device. The method also includes the operations of providing a cartridge portion connected to the controller portion by way of a multi-media content address/data bus having a slave processor arranged to decode the multi-media content file as directed by the host processor a mailbox coupling the slave processor to the host processor arranged as an addressable latch configured to provide an information channel between the host processor and the slave processor, and an I/O interface wherein when an external device coupled to the external interface includes an external controller, the external controller supercedes the host processor such that the external device is enabled to store selected multi-media content to the multi-media card.

In still another embodiment, a method of using a personal multi-media device having a host processor, a keypad connected to the host processor arranged to receive a user supplied command, and a display unit arranged to display an image, or a series of correlated images, derived from a multi-media content file stored in a multi-media card connected to the personal multi-media device and a multi-media content address/data bus connecting the host processor to a slave processor by way of a mailbox arranged to decode the multi-media content file as directed by the host processor, wherein the mailbox is arranged as an addressable latch configured to provide an information channel between the host processor and the slave processor, and an I/O interface wherein when an external device coupled to the external interface includes an external controller, the external controller supercedes the host processor such that the external device is enabled to store selected multi-media content to the multi-media card is disclosed. Power is provided to the PMD and the host processor is initialized and the slave processor is initialized as directed by the host processor. If a multi-media card is connected to the PMD, then a selected multi-media content file is downloaded from the multi-media card based upon a user supplied selection command whereas the selected multi-media content file is then parsed by the slave processor. Based upon the parsing, an image data file is passed to the mailbox by the slave processor and the host processor is notified that the mailbox has the image data file. Next, an audio content file is decoded by the slave processor associated with the image data file after which substantially simultaneously the image data file is output by the host processor and the decoded audio content file is output by the slave processor.

### BRIEF DESCRIPTION OF THE DRAWINGS

FIG. 1 illustrates a personal media device (PMD) in accordance with an embodiment of the invention.

FIG. 2 illustrates a multimedia data packet in accordance with an embodiment of the invention.

FIGS. 3-4 illustrate a flowchart detailing a process for operating the personal media device in accordance with an embodiment of the invention.

FIG. 5 shows a flowchart detailing an interrogate connected device process in accordance with the invention as described with reference to the process shown in FIG. 3.

FIG. 6 shows a personal multi-media device in accordance with a particular embodiment of the invention.

FIG. 7 shows a multi-media distribution system in accordance with an embodiment of the invention.

FIG. 8 shows a flow chart detailing a process for distributing a user selected multi-media content file in accordance with an embodiment of the invention.

FIG. 9 illustrates a multimedia content distribution apparatus in the form of a vending machine in accordance with an embodiment of the invention.

FIG. 10 shows a flowchart detailing a process for using the inventive vending machine 900 in accordance with an embodiment of the invention.

FIG. 11 illustrates a typical, general-purpose computer system suitable for implementing the present invention

### DESCRIPTION OF SELECTED EMBODIMENTS OF THE INVENTION

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Broadly speaking, a configurable and portable personal media device (PMD) capable of playing any number and type of digital multi-media content is described. In one aspect of the invention, the PMD includes a controller portion having a host processor, a keypad connected to the host processor arranged to receive a user supplied command, and a display unit arranged to display an image, or a series of correlated images, derived from a multi-media content file stored in a multi-media card connected to the personal multi-media device. The PMD also includes a cartridge portion connected to the controller portion by way of a multi-media content address/data bus having a slave processor arranged to decode the multi-media content file as directed by the host processor, and a mailbox coupling the slave processor to the host processor arranged as an addressable latch configured to provide an information channel between the host processor and the slave processor.

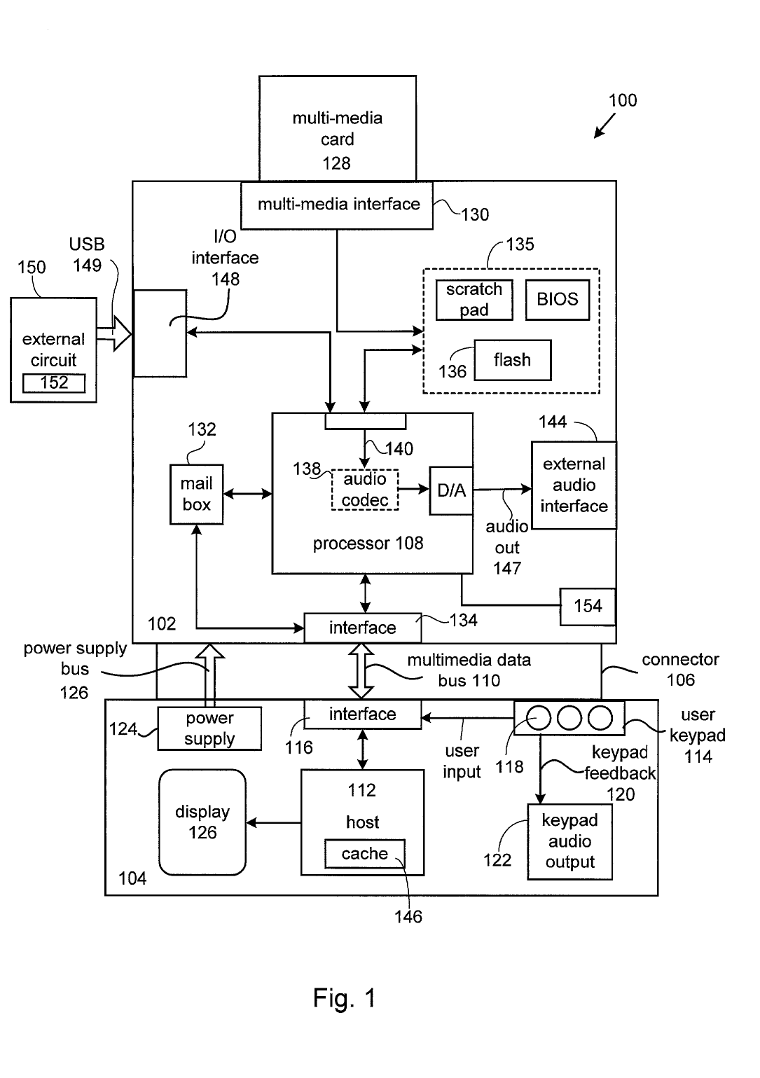

FIG. 1 illustrates a personal media device (PMD) in accordance with an embodiment of the invention. The PMD 100 includes a cartridge portion 102 connected to a controller portion 104 by way of a connector 106. In the described embodiment, the cartridge portion 102 includes a processor 108 arranged to receive data and execute instructions by way of a multi-media address/data bus 110 (such as an HPI type data bus) provided by a host processor 112. In this context, therefore, the slave processor 108 is hereinafter referred to as a slave processor 108 since its operations are substantially directed by the host processor 112.

A user keypad 114 coupled to the host processor 112 by way of a control portion interface 116 provides user supplied commands to the host processor 112. Typically, when a user supplied command is invoked by depressing, or otherwise activating one or more input buttons 118 included in the key pad 114, a keypad feedback signal 120 is sent to a keypad feedback indicator 122 in order to provide real time feedback to the user. This real time feedback can take many forms such as an audible beep, tone, buzz, etc. or in some cases, the real time feedback can take the form of a visible signal such as a light, LED, video display message, etc or any appropriate combination thereof.

In the described embodiment, the controller portion 104 also includes a power supply unit 124 arranged to provide power (typically DC power) to the cartridge portion 102 by way of a power supply bus 126. The power supply unit 124 can take the form of a battery, an AC power converter unit for converting externally supplied AC power to an appropriate DC power. It should be noted, however, that an external power supply can also be provided in those cases where such an arrangement is deemed suitable for the particular application at hand.

In those situations where an image or images are to be displayed, the host processor 112 sends the appropriate image data frame to a display 126. Typically, the display 126 is a low resolution LCD array suitable for displaying a single low resolution still image or in some cases, a correlated series of still images that taken together, form a low resolution video stream.

The display 126 can therefore be used in any number of ways to display images related to, for example, multi-media content stored in a multi-media card (MMC) 128 coupled to the cartridge portion 102 by way of a multi-media interface 130. In the described embodiment, the interface 130 is capable of providing the necessary interface for any number of media devices, such as smartcards, flash memory (such as Memory Sticks™ manufactured by Sony Corporation) and any other such memory devices. Such images can be related to particular audio content currently being played by the player 100 showing a particular artist, title, track number, etc. Such images can also be related to advertising content in the form of ads and or other commercial images.

In the described embodiment, the cartridge unit 102 includes a mailbox 132 coupling the slave processor 108 to the host processor 112 by way of a cartridge portion interface 134 and the controller interface 116. The mailbox 132 takes the form of an addressable latch such as a buffer, register, or any appropriate storage medium suitable for storing data, status flags, instructions, etc. associated with the operations of the processors 112 and 108. For example, in some cases, the slave processor 108 can use the mailbox 132 to signal the host processor 112 that an image data frame is available by setting a data available flag in the mailbox 132 to a SET condition, or conversely, that no data is available to the host processor 112 by resetting the data available flag to a RESET condition. In this way, the mailbox 132 can be used by either processors 108 or 112 to indirectly communicate associated processor states as well as data availability and their associated status flags. In some cases, the slave processor 108 can store data to be made available to the processor 112 for subsequent processing. Such data can include text files having, for example, track numbers associated with multi-media content stored in the multi-media card 128 or stored in a memory unit 135, and more particularly, a flash type memory array 136 included in the memory unit 135.

It should be noted that in the described embodiment, the slave processor 108 is a multi-function processor capable of supporting any number of functions and operations simultaneously. One such function is represented by an audio codec 138 that is used to decode a digital audio stream 140 received from, for example, the flash memory array 136. Typically, the codec 138 is coupled to a digital to analog (D/A) unit 142 that serves as an interface between the codec 138 and an external audio interface 144 such as a earphone jack, loudspeaker, or any other suitable analog transducer. In this way, in those cases that a particular digital audio file has associated with it an image file, the slave processor 108 decodes the digital audio file (represented by the digital audio stream 140), sets the data available flag in the mailbox 132, stores the associated image file in the mailbox 132 so as to be made available to the host processor 112. The host processor 112 can then retrieve the image file stored in the mailbox 132 to a cache memory 146 where it is ultimately displayed at the display 126 synchronously with the slave processor 108 decoding the digital audio stream 140 as an audio output stream 147.

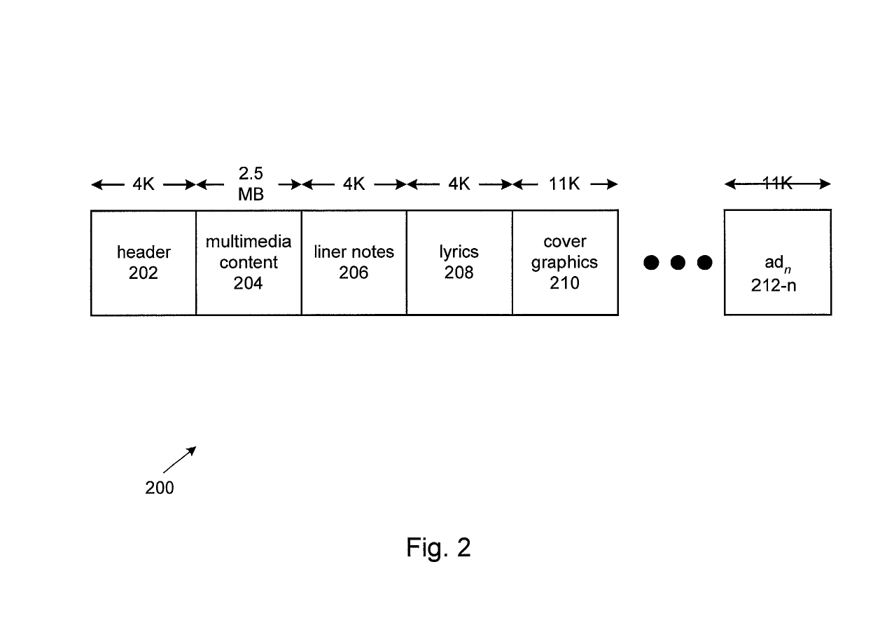

During operation, a user can provide any number and kind of multimedia content, such as music, videos, etc. by way of the multi-media interface 130 and/or an I/O interface 148 in the form of a multimedia data packet 200 as illustrated in FIG. 2. When using the I/O interface 148, for example, the user can couple the PMD 100 to a universal serial bus (USB) 149 connected to external circuitry 150 arranged to transmit a multimedia data packet 200 that is used to overwrite some, or all, of the multi-media content stored in the multi-media card 128. In these cases, the external circuitry 150 typically takes the form of a computing device (such as a personal computer, modem, and the like) having an associated external processor unit 152 which is given priority over the host processor 112 during the period of time required to transfer and store the new multi-media content in the multi-media card 128.

Referring to FIG. 2, the multimedia data packet 200 includes various data fields each capable of providing various multimedia content and associated information to the PMD 100. For example, the multimedia data packet 200 includes a header field 202 that describes and/or identifies the type of multimedia content associated with the multimedia data packet 200. Such formats of multimedia content includes .WAV files, MP3 files, and WMA type files. Other data fields included in the multimedia data packet 200 includes a multimedia content file 204 that contains the actual multimedia content to be output by either the display 126 and/or the external audio interface 144.

For example, if the header file 202 indicates that the multimedia data packet 200 is a MP3 type data file, then the associated multimedia content file 204 contains the appropriately encoded music described by a liner notes file 206. In the described embodiment, the liner notes file 206 includes a various descriptors associated with the multimedia content included in the multimedia content file 204. Such descriptors include, for example, titles, authors, copyright notices, etc. In addition to the liner notes file 206, the multimedia data packet 200 can include a lyrics data file 208 well suited for providing, for example, “sing-a-longs” typical of many karioke applications. The multimedia data packet 200 also includes at least one cover graphics data field 210 used to store an image frame file(s) associated with the multimedia content file 204. The multi-media data packet 200 has the advantage that it can also include various ad files 212-1 through 212-n specifically directed at the listener who has selected the particular multimedia data packet 200.

Referring back to FIG. 1, during operation of the PMD 100, when an external device is connected to the I/O interface 148, the external host processor 152 associated with the external device is given priority over the host processor 112. The external host processor 152 is then enabled to pass selected multimedia data packet(s), such as data packet 200, to the multi-media card 128 in order to be stored therein. When all appropriate data packets have been stored, the external device 150 is disconnected and priority is passed back to the host processor 112. The host processor 112 then directs the slave processor 108 to store a selected multi-media data packet(s) to the flash memory 136. In some cases, however, the external host processor 152 stores data packet(s) 200 directly to the flash memory 136 by way of the slave processor 108. The slave processor 108 then retrieves the data packet 200 and then parses the multimedia data packet 200 into its various constituent data fields. The slave processor 108, acting as a digital signal processor (DSP) then processes the appropriate audio data fields using the codec 138 and sends any image and or text date fields to the mailbox 132 to be retrieved, processed and displayed by the host processor 112 when appropriate.

It should be noted that all through this process, the various user input controls 118 included in the user keypad 114 provide feedback control to the processor 112 (or the slave processor 108) in order to control volume, display brightness, data file selection, input device selection, etc.

In some cases, a user can insert a memory device into the media interface 130 in order to download a selected multimedia content to the memory unit 135 for playback at a later time. In addition to providing playback options, the memory unit 135, in conjunction with either the media interface 130 and/or the I/O interface 148 allows the user to record his or her own music, for example, create a personal playlist of which various selections can be added or deleted as desired.

It is one of the advantages of the inventive PMD 100 that the cartridge portion 102 is capable of providing any number and type of multimedia content to the controller portion 104 for display therein. For example, a user can provide a PowerPoint™ demonstration on the display 126 simply by downloading the appropriate PowerPoint™ data file with an appropriate conversion. In other cases, the PMD 100 can be connected by way of a modem 154, for example, to a network of remote computers, such as the Internet, where the user can, for example, subscribe to a daily comic book service, or where the user can download selected digital images stored in a central server thereby using the PMD 100 as a form of a personal picture frame.

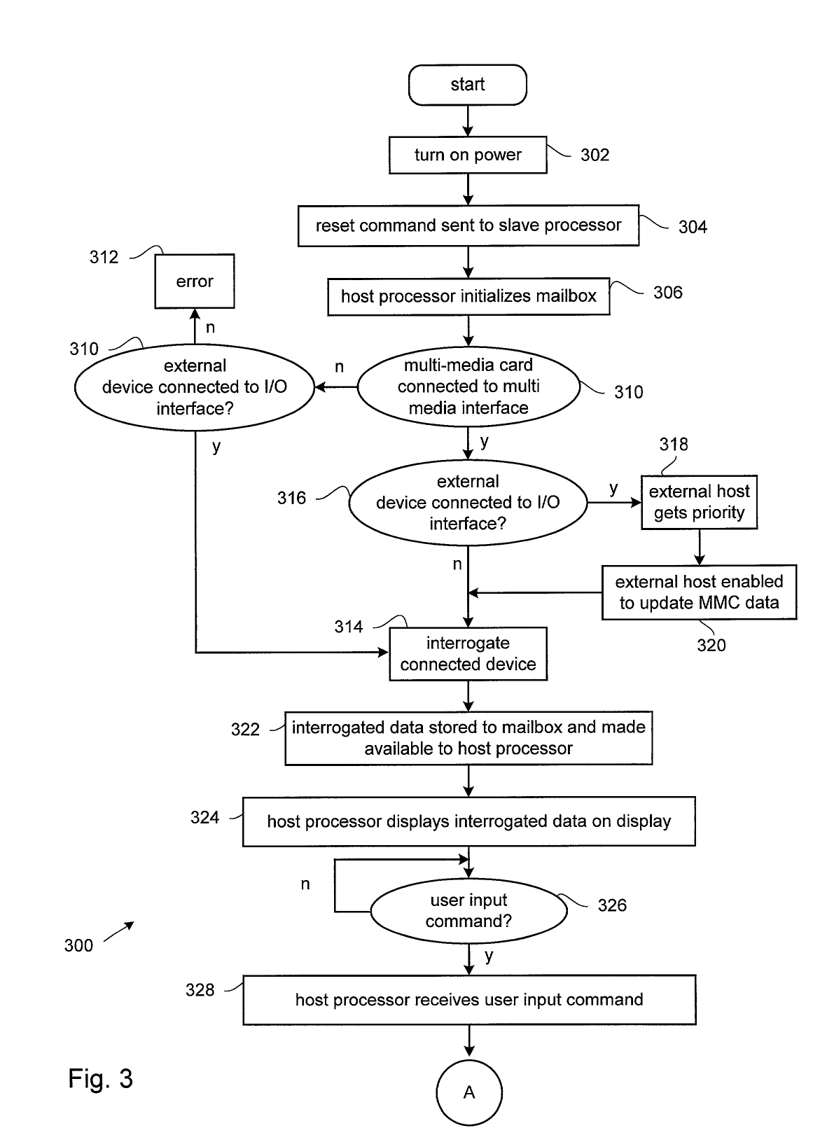

FIG. 3 illustrates a flowchart detailing a process 300 for operating the personal media device in accordance with an embodiment of the invention. The process 300 begins at 302 by turning on the power supply, or otherwise providing appropriate power to the PMD. Once appropriate power has been supplied to the PMD, an initialization cycle is started by the host processor based upon a BIOS stored in the cartridge memory unit. As part of the initialization process, a reset command is sent to the slave processor at 304 that results in “waking up” the slave processor so it can accept and execute commands from the host processor. In addition to waking up the slave processor, the host initializes the mailbox by clearing any previously stored mailbox data at 306. Next, at 308 a determination is made whether or not a multi-media card is connected to the multi-media interface. If it is determined that there is no multi-media card connected to the multi-media interface, then a determination is made at 310 whether or not an external device is connected to the I/O interface. If it is determined that there is no external device connected to the I/O interface, then an error flag is thrown at 312 so as to notify the user and further operation of the PMD is halted unit the error condition has been corrected.

If, however, it is determined that an external device is connected to the I/O interface, then at 314 the connected device is interrogated in order to determine the type of device connected thereto.

Returning to 308, if it had been determined that a multi-media card is in fact connected to the multi-media interface, then at 316 a determination is made whether or not an external device is connected to the I/O interface. If it is determined that there is no external device connected to the I/O interface, then control is passed to 314, otherwise, an external host processor associated with the connected external device is given priority at 318. At 320 the external host processor is then enabled to update any or all data stored in the multi-media card, if desired, after which control is then passed to 314.

At 322, the interrogation data is stored to the mailbox and made available to the host processor which, in turn, displays the interrogation data on the display at 324 (if appropriate). Once the connected device has been interrogated, the host processor executes at 326, in a loop fashion, a query to determine whether or not any user-supplied commands have been invoked. Such user-supplied commands include, select, play, volume up or down, skip to next track, set equalizer settings, etc based upon the interrogation data. When a user-supplied command is invoked, the command is received by the host processor at 328.

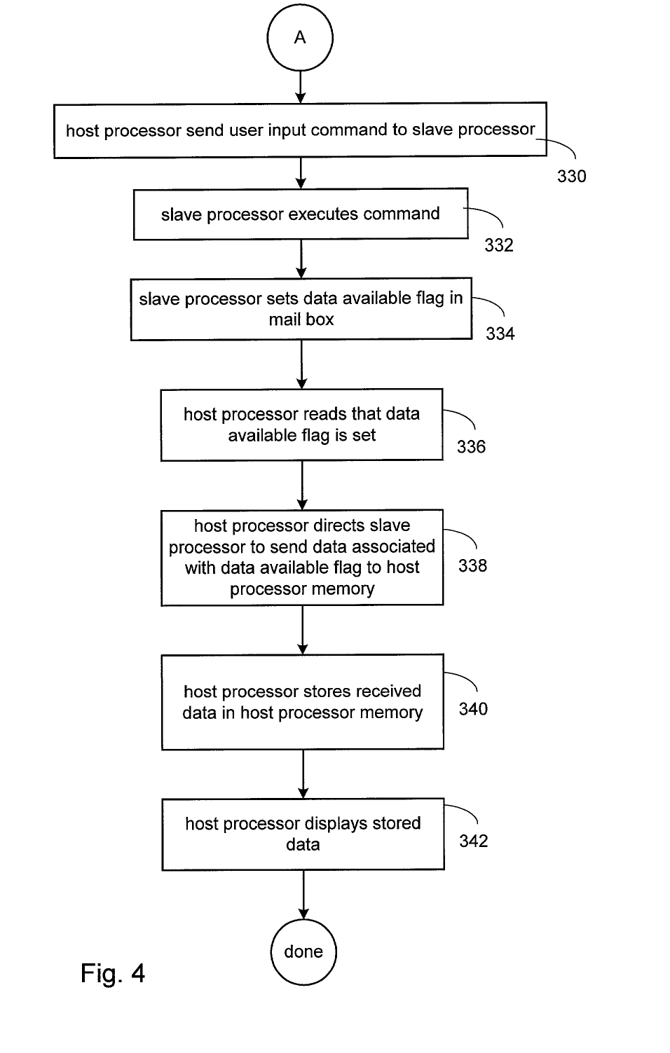

Referring to FIG. 4, at 330 the host processor sends the user input command to the slave processor by way of the mailbox. The slave processor executes retrieves and executes the command at 332 and in response, the slave processor sets a data available flag in the mailbox based upon the executed command at 334. The host processor is then notified that the data available flag has been set at 336 and in response, the host processor directs the slave processor to send the data associated with the set data available flag to the host processor memory at 338. The host processor stores the received data in the host processor memory at 340 after which the host processor displays the stored data at 342.

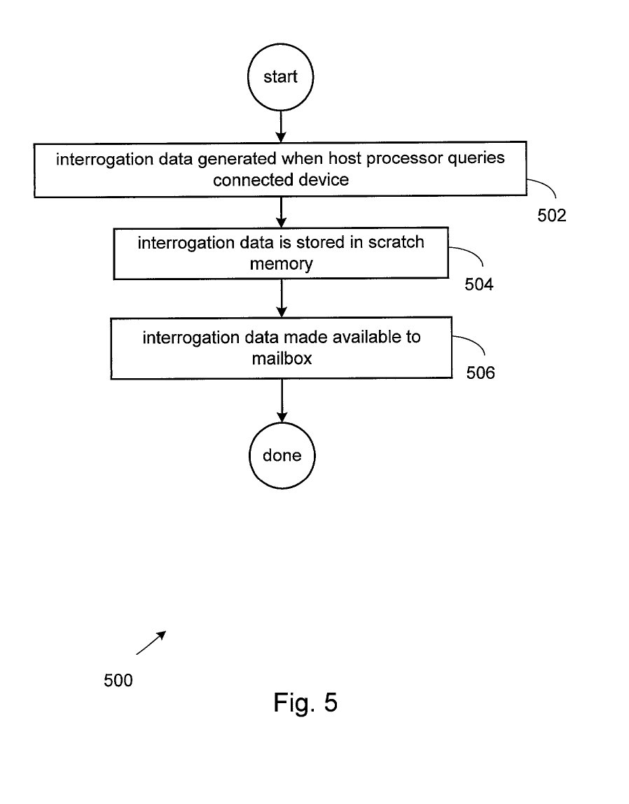

FIG. 5 shows a flowchart detailing an interrogate connected device process 500 in accordance with the invention as described with reference to the operation 314 of the process 300 shown in FIG. 3. It should be noted that the process 500 is but a particular embodiment of the operation 314 of the process 300 and should therefore not be considered to be limiting either the scope or intent of the invention. The process 500 begins at 502 by the host processor determining the type of the connected device, the size of memory (if any) associated with the connected device, and any tag file format information associated with any data stored in the memory. Next, at 504, the interrogation data is stored in a scratch memory array included in the cartridge memory unit which is then made available to be stored in the mailbox at 506.

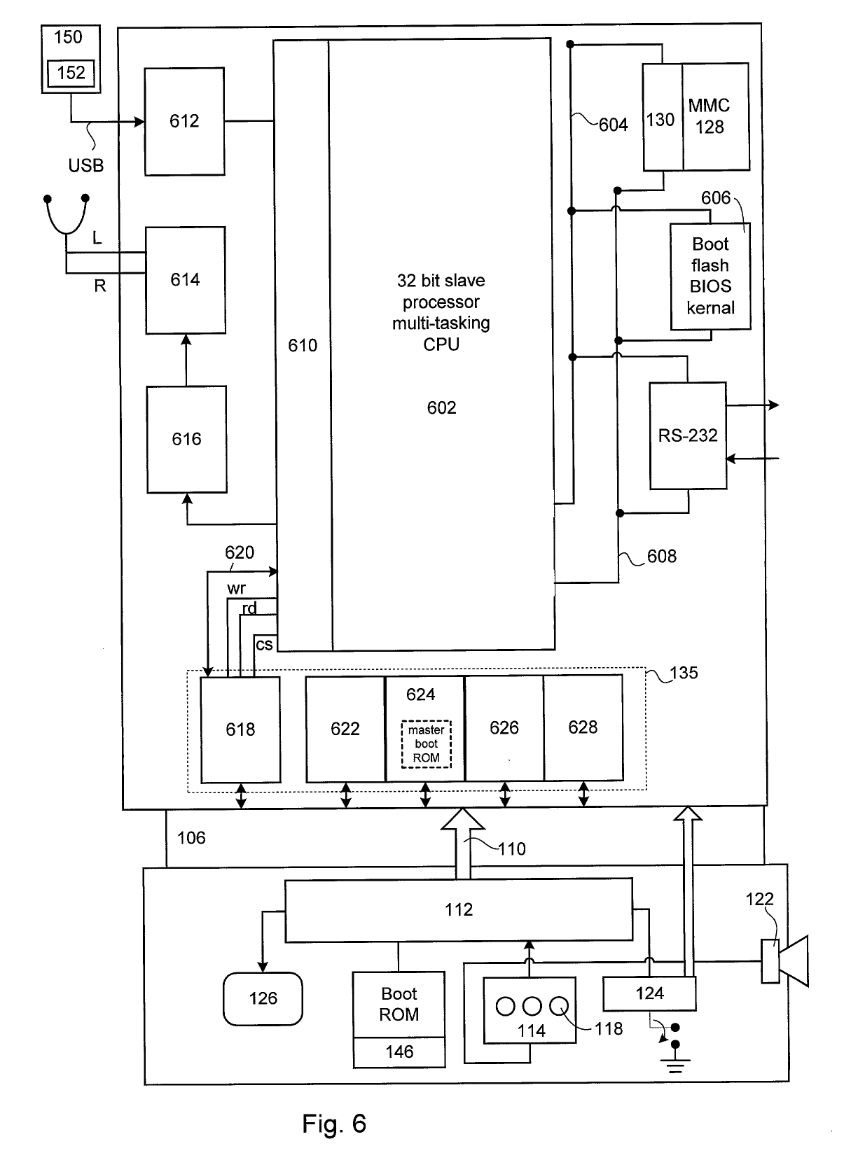

FIG. 6 shows a personal multi-media device 600 in accordance with a particular embodiment of the invention. It should be noted that the personal multimedia device 600 is a particular implementation of the PMD100 shown in FIG. 1 and therefore should not be considered to be limiting either the scope or intent of the invention. Accordingly, the cartridge portion 102 of the PMD 600 includes a 32 bit multi-tasking slave central processor unit (CPU) 602 having a 32 bit slave address bus 604 coupled to the multi-media interface 130 (and the associated multi-media card 129), a boot flash BIOS kernal 606, and an RS 232 port. It should be noted that the boot flash BIOS kernal 606 is used to initialize (i.e., boot up) the slave CPU 602 during the initialization procedure. In addition to the slave address bus 604, a 32 bit slave data bus 608 couples the slave CPU 602 with the multi-media interface 130, the boot flash BIOS kernal 606, and the RS 232 port.

In the described embodiment, an I/O bus 602 connects the slave CPU 602 to the external circuit 150 and associated external host processor 152 by way of a USB interface 612 whereas the I/O bus 612 connects the external audio interface 144 in the form of an amplifier unit 614 to the slave CPU 602 by way of an external codec coprocessor 616. In this particular implementation, the memory unit 135 includes the mailbox 132 in the form of an 8 bit bi-directional latch 618 having an 8 bit data bus 620 in addition of a write enable (WR) line, a read enable (RD) line, and a chip select (CS) line each of which is connected to the I/O bus 610. Additionally, the memory unit 135 includes CPLD decoder logic 622, a host EEPROM 624 (that includes the host processor master boot ROM), scratch pad memory 626, as well as the flash memory 136 in the form of an image buffer flash RAM 628 each of which is bi-directionally connected to the multi-media address/data bus 110 incorporated into the connector 106.

The controller portion 102 includes the host processor 112 connected to the display 126, a memory array 630 (of which approximately 32 kB of memory are used to store a boot ROM), the cache memory 146, and the keyboard 114. In the described embodiment, the keypad audio output 122 takes the form of a speaker 632 whereas the power supply 124 is a general purpose switched power supply.

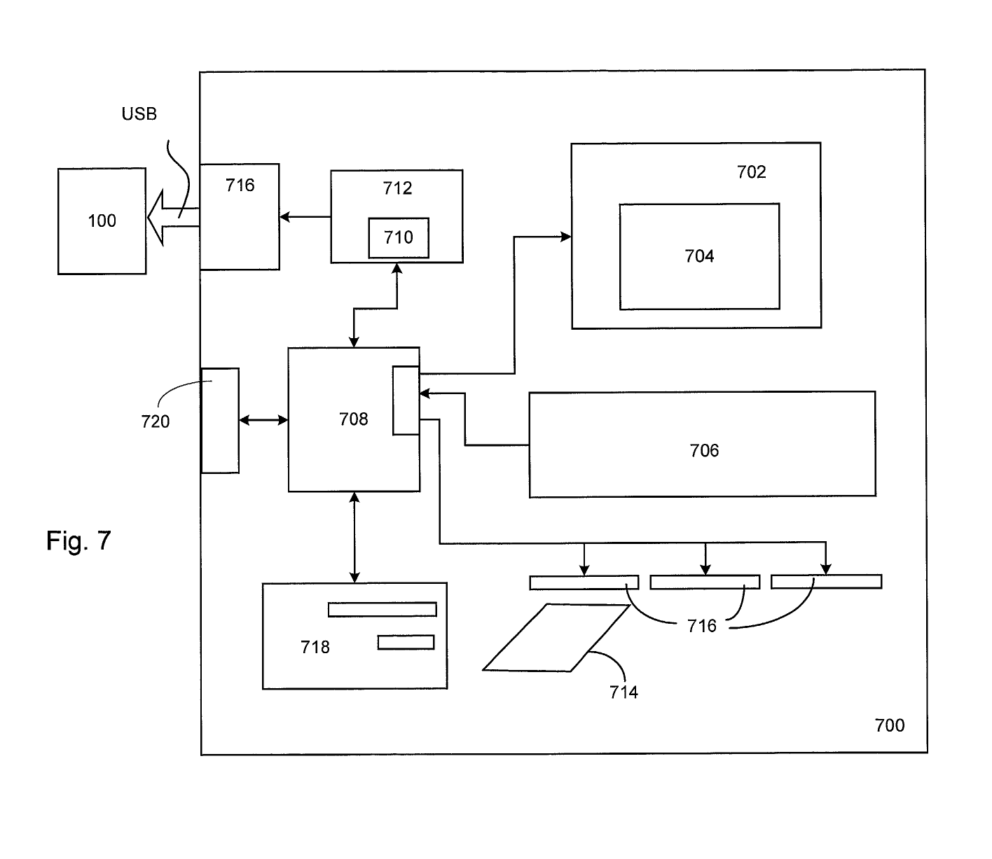

A multi-media content distribution system and methods of use thereof are now described. In one aspect of the invention, the multi-media distribution system takes the form of a multi-media docking station arranged to selectively supply any number and/or type of multi-media content to a user supplied storage medium such as the PMD 100. Accordingly, FIG. 7 shows a multi-media distribution system 700 in accordance with an embodiment of the invention.

In one embodiment of the invention, the multi-media docking station 700 includes a display monitor 702 arranged to display a selection of available multi-media content 704, a user input device 706 (such as a keyboard, touchpad, mouse, etc.) used to provide user input commands to a host processor unit 708. (It should be noted that in subsequent discussions, the host processor 708 is in fact the external host processor 152 described above). The host processor unit 708, in turn, executes any received user input command by retrieving a selected multi-media content file(s) 710 from a memory device 712 coupled thereto based upon the particular user selection input command. The selected multi-media content file(s) 710 is then transferred in a file format appropriate to a selected user supplied storage medium 714 (such as, for example, a MemoryStick by Sony Corp, CompactFlash by Sandisk Corp, etc.) by way of any number of I/O ports 716. It should be noted that the user supplied storage medium does in fact include the multi-media memory card 128 described above.

In a preferred embodiment, the multi-media docking station 700 further includes a remuneration input port 718 suitably arranged to receive any number and type of monetary compensation media, such as cash, credit cards, debit cards, and the like. In this way, a user can select any number of multi-media files for purchase in real time. In some cases, if the selected multi-media content file is not locally available to the docking station 700, a remote file request can be made to , for example, a distributed network of computing devices (such as the InternetO by way of an interface 722 (such as a modem, DSL port, etc.).

For the remainder of this discussion, it will be assumed that a user having a PMD 100 desires to download selected multi-media content files from the docking station 700 to the multi-media card 128 connected to the MMI 130 described above. Accordingly, once a user has selected a multi-media content file(s) to download to the MMC 128, the user connects the PMD 100 to the docking station 700 by way of the USB port 148. At this point, the docking station 700 becomes, in effect, the external device 150 with respect to the PMD 100 and the host processor 702 becomes, in effect, the external host processor 152. In this way, the host processor 702 supercedes the host processor 112 and directly downloads the selected multi-media file(s) to the MMC 128. Once the download process has been completed, the user disconnects the PMD 100 from the docking station 700 thereby re-establishing the priority of the host processor 112 in the PMD 100. It should be noted, that if desired, the docking station 700 can download selected multi-media content files concurrently to any number of connected user supplied storage media (for possible additional cost).

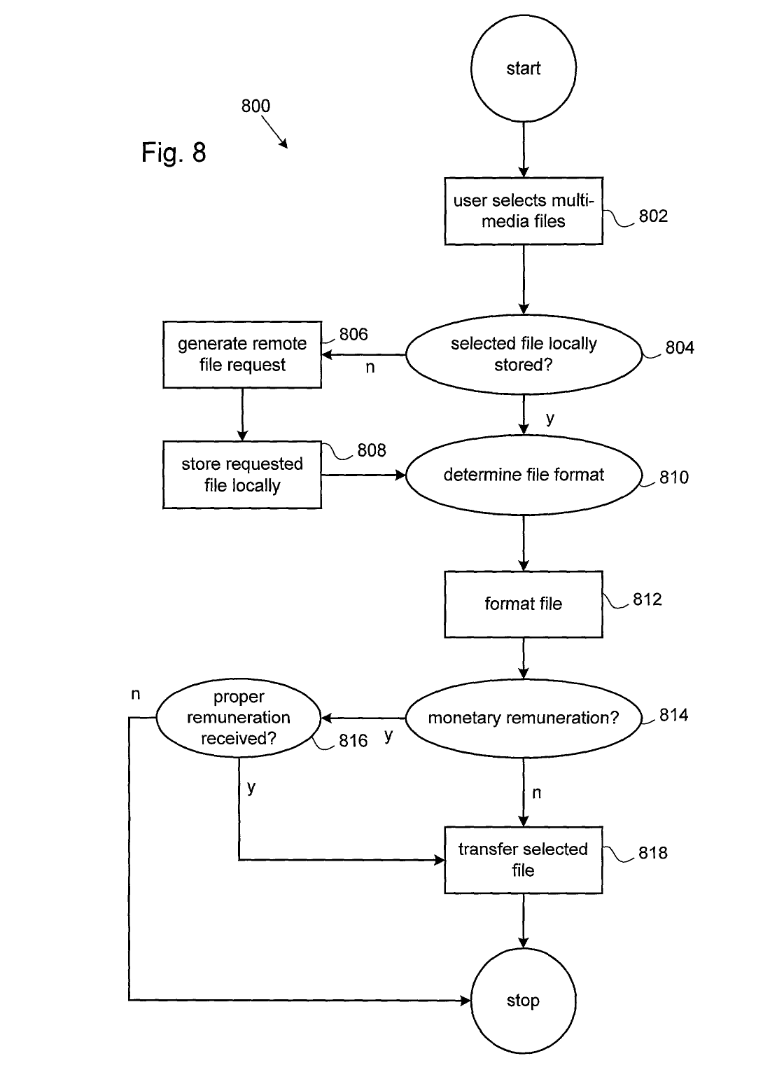

FIG. 8 shows a flowchart detailing a process 800 for distributing selected multi-media content file(s) in accordance with an embodiment of the invention. At 802, a user selects a particular multi-media content file from a list of available multi-media content files displayed on a display unit coupled to the docking station. Based upon the user selection, at 804, a host processor determines if the selected file(s) are stored locally in a mass storage medium coupled to the docking station. If it is determined that the request file(s) is not stored locally, then a remote file request is generated at 806 and the requested file is stored to the mass storage medium at 808. Once retrieved, the host processor determines a type of user supplied storage medium that is to be used to store the selected multi-media file then formats the selected file(s) at 810. At 812, a determination is made whether or not monetary remuneration is required. At 814, if monetary remuneration is required, the host processor determines if the proper compensation has been received from a remuneration port. At 816, if the host processor determines that proper remuneration has been received, the host processor proceeds to transfer the selected file(s) in the appropriate format to the selected user supplied storage medium at 818.

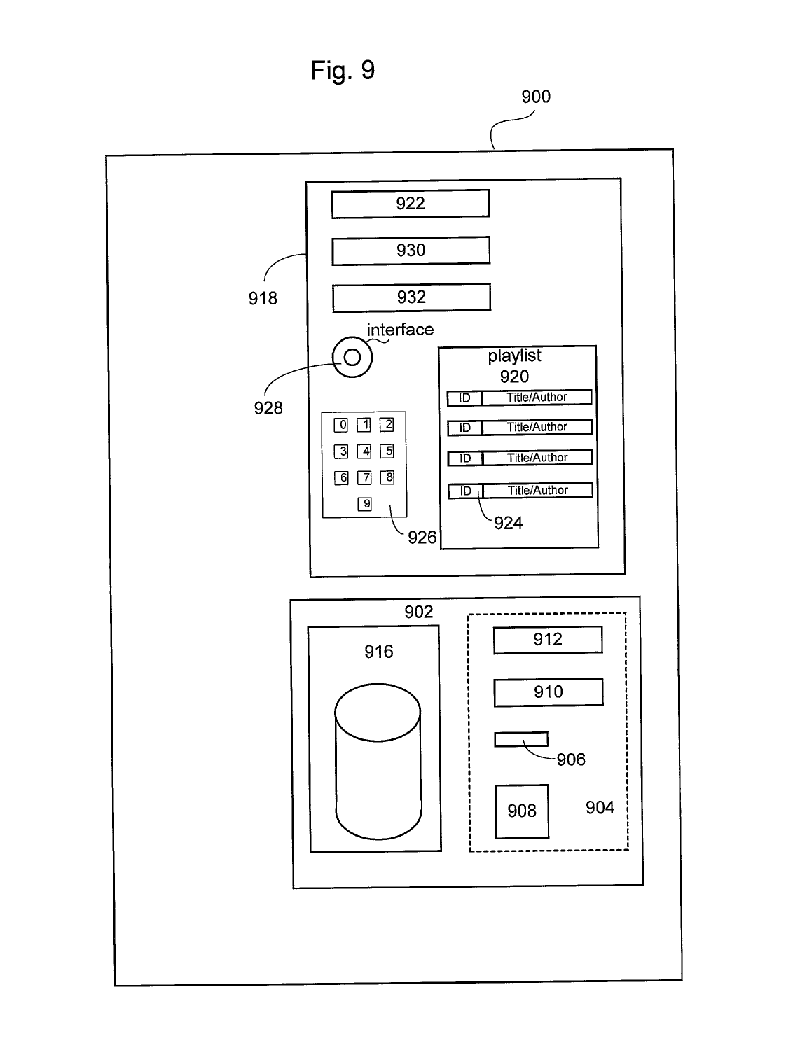

FIG. 9 illustrates a multimedia content distribution apparatus in the form of a vending machine 900 in accordance with an embodiment of the invention. The vending machine 900 includes a conventional vending portion 902 suitable for vending consumables, such as drinks, snacks, etc. as selected by a user. The vending portion 902 includes a payment portion 904 that further includes a coin receiver 906, a coin change return 908, a currency receiver 910, and in a preferred embodiment, a smartcard interface 912. The smartcard interface 912 is arranged to receive a smartcard 914 that includes various datafields related to the amount of credits available, the name of the purchaser, etc. Typically, in the case of a drink vending machine, the user will choose a particular drink to be dispensed, pay for the drink with either currency or the smartcard and the once approved, the drink will be dispensed at a dispensing portion 916.

In addition to the conventional vending portion 902, the inventive vending machine 900 includes a multimedia content dispenser 918 configured to provide the vending machine user with the option of downloading selected multimedia content, such as a song, stored therein as indicated by a playlist 920 by way of a number of available interfaces. One such interface is a memory slot 922 capable of downloading a selected song, for example, from on-board memory (not shown) based upon an id number 924 that, in one embodiment, is manually input by way of a keypad 926. The multimedia dispenser 918 can also include other interfaces such as a universal serial bus (USB) port 928, a floppy disk bay 930, or in some cases, a R/W CD or DVD port 932.

It is a particularly profitable aspect of the current invention that the purveyors of snacks and drinks can synergistically combine marketing and sales strategies with the dispensing of the multimedia content to the advantage of both. For example, the snack and drink purveyor can link the purchase of a drink or snack with a free, or at least discounted, download of a song, for example. In other cases, the purveyor of the multimedia content can provide a free, or substantially discounted, download of a popular song thereby increasing the traffic to the vending machine 900 resulting in an increase the sales of drinks or snacks than would otherwise be likely.

It should also be noted that the vending machine 900 can be connected to a network of remote computers, such as the Internet, or to a local computer or memory storage device so as to increase the capacity and thereby the possible selections available to the user.

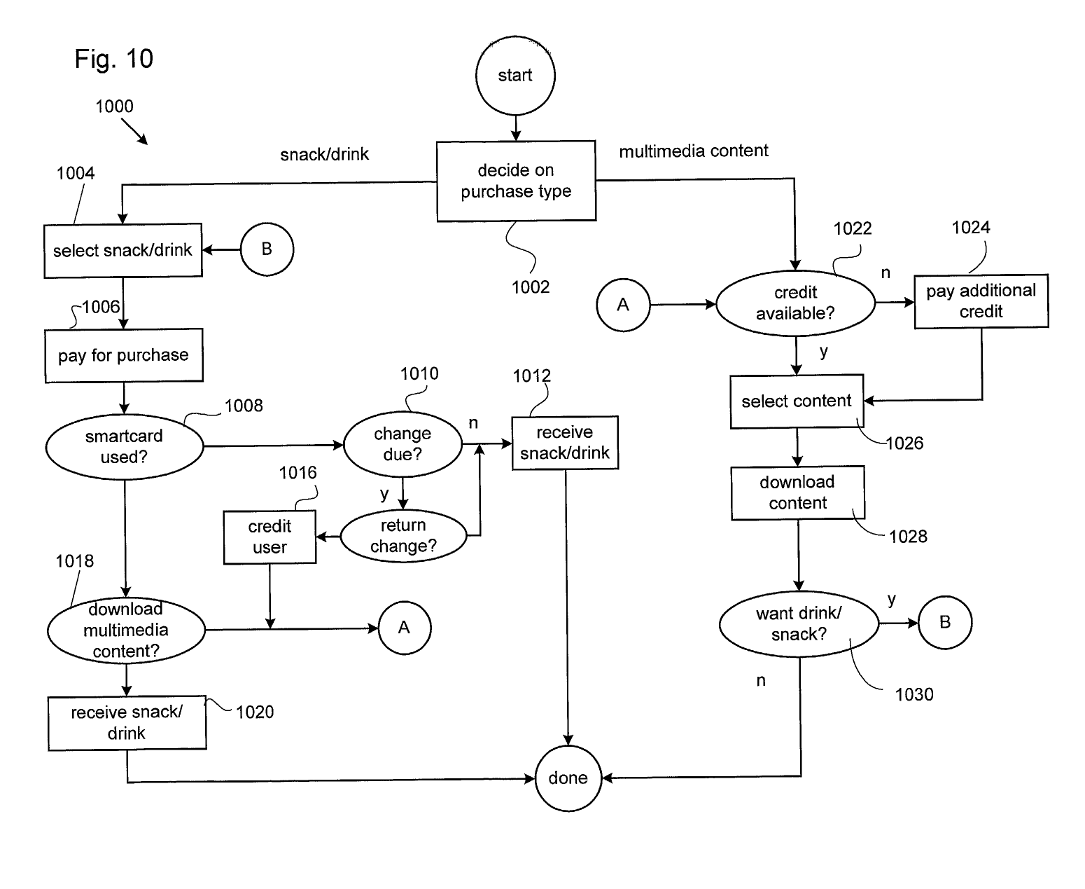

FIG. 10 shows a flowchart detailing a process 1000 for using the inventive vending machine 900 in accordance with an embodiment of the invention. The process 1000 begins at 1002 by a user deciding whether to purchase a snack/drink or downloading selected multimedia content. When purchasing a snack/drink, the user selects a particular snack/drink at 1004. At 1006, the user pays for the purchase. If a smartcard is not used at 1008, then a determination is made at 1010 whether or not there is change due the user. If there is no change due, then the user receives the selected snack/drink at 1012, however, if there is change due than a determination is made at 1014 whether the change is returned to the user or credited towards the purchase of a selected multimedia content at 1016.

Returning to 1008, if a smartcard, or the like, is used to purchase the snack/drink, a determination is made at 1018 whether or not the user would like multimedia content as well. If the user does not desire multimedia content at this time, then the selected snack/drink is dispensed at 1020, otherwise control is passed to 222.

Returning to 1002, if the user desires to purchase a downloadable multimedia content, then a determination is made at 1022 if sufficient credit is available and if not then additional credit is paid at 1024. Otherwise, at 1026, the user selects the particular multimedia content to download at 1028. At 1030, the user has the option to select a drink or snack. If the user desires to select a drink or snack, then control is passed to 1004, otherwise the process 1000 is complete.

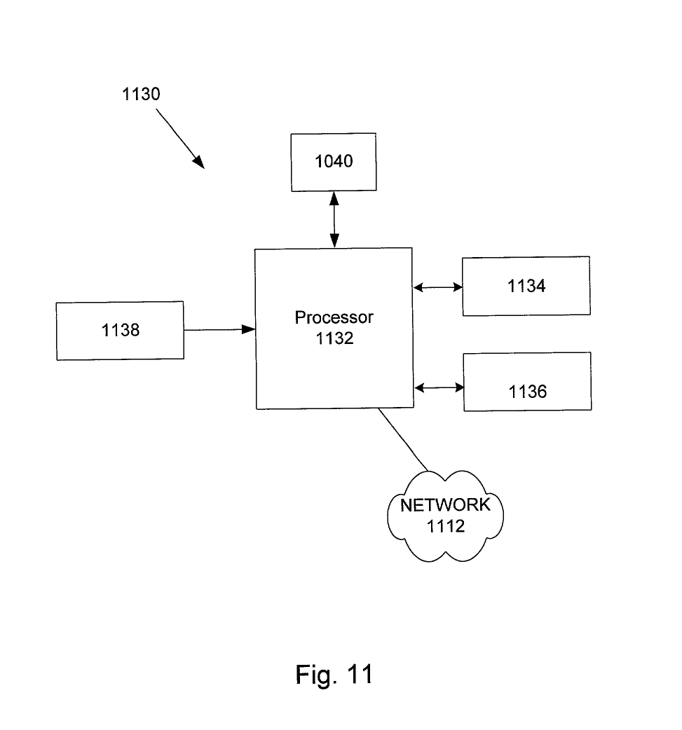

FIG. 11 illustrates a typical, general-purpose computer system 1130 suitable for implementing the present invention. The computer system 1130 includes at least one processor 1132 (also referred to as a central processing unit, or CPU) that is coupled to memory devices including primary storage devices 1136 (typically a read only memory, or ROM) and primary storage devices 1134 (typically a random access memory, or RAM).

Computer system 1130 or, more specifically, CPUs 1132, may be arranged to support a virtual machine, as will be appreciated by those skilled in the art. As is well known in the art, ROM acts to transfer data and instructions uni-directionally to the CPUs 1132, while RAM is used typically to transfer data and instructions in a bi-directional manner. CPUs 1132 may generally include any number of processors. Both primary storage devices 1134, 1136 may include any suitable computer-readable media. A secondary storage medium 1138, which is typically a mass memory device, is also coupled bi-directionally to CPUs 1132 and provides additional data storage capacity. The mass memory device 1138 is a computer-readable medium that may be used to store programs including computer code, data, and the like. Typically, mass memory device 1138 is a storage medium such as a hard disk or a tape which generally slower than primary storage devices 1134, 1136. Mass memory storage device 1138 may take the form of a magnetic or paper tape reader or some other well-known device. It will be appreciated that the information retained within the mass memory device 1138, may, in appropriate cases, be incorporated in standard fashion as part of RAM 1136 as virtual memory. A specific primary storage device 1134 such as a CD-ROM may also pass data uni-directionally to the CPUs 1132.

CPUs 1132 are also coupled to one or more input/output devices 1040 that may include, but are not limited to, devices such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPUs 1132 optionally may be coupled to a computer or telecommunications network, e.g., an internet network or an intranet network, using a network connection as shown generally at 1112. With such a network connection, it is contemplated that the CPUs 1132 might receive information from the network, or might output information to the network in the course of performing the above-described method steps. Such information, which is often represented as a sequence of instructions to be executed using CPUs 1132, may be received from and outputted to the network, for example, in the form of a computer data signal embodied in a carrier wave. The above-described devices and materials will be familiar to those of skill in the computer hardware and software arts.

While this invention has been described in terms of a preferred embodiment, there are alterations, permutations, and equivalents that fall within the scope of this invention. It should also be noted that there are many alternative ways of implementing both the process and apparatus of the present invention. It is therefore intended that the invention be interpreted as including all such alterations, permutations, and equivalents as fall within the true spirit and scope of the present invention.

In the claims:

1. A personal multi-media device, comprising:
a controller portion having,
a host processor,
a keypad connected to the host processor arranged to receive a user supplied command, and
a display unit arranged to display an image, or a series of correlated images, derived from a multi-media content file stored in a multi-media card connected to the personal multi-media device; and
a cartridge portion connected to the controller portion by way of a multi-media content address/data bus having,
a slave processor arranged to decode the multi-media content file as directed by the host processor,
a mailbox coupling the slave processor to the host processor arranged as an addressable latch configured to provide an information channel between the host processor and the slave processor, and
an I/O interface wherein when an external device coupled to the external interface includes an external controller, the external controller supercedes the host processor such that the external device is enabled to store selected multi-media content to the multi-media card.

2. A personal multi-media device as recited in claim 1, wherein the cartridge portion further comprises:
a memory unit arranged store a selected multi-media content file;
a multi-media interface configured to connect the multi-media card to the slave processor; and
a modem arranged to connect the slave processor to a distributed network of interconnected computers.

3. A personal multi-media device as recited in claim 1, wherein the multi-media content is stored on the multi-media card as a multi-media data packet, wherein the multi-media packet includes,
a header portion arranged to identify a multi-media file type associated with a particular multi-media file, and
a payload portion arranged to store the multi-media content corresponding to the associated multi-media type.

4. A personal multi-media device as recited in claim 3, wherein the multi-media data packet further comprises:
a liner notes portion corresponding to the payload portion;
at least one advertising portion corresponding to the header portion arranged to provide an advertisement file; and
a cover graphics portion corresponding to the payload portion.

5. A personal multi-media device as recited in claim 4, wherein the multi-media data packet further includes a plurality of correlated graphics portions used to form a video stream that is displayed on the display unit.

6. A personal multi-media device as recited in claim 1, further comprising:
in the controller portion,
a power supply unit arranged to provide an appropriate power supply voltage to the cartridge portion and the controller portion; and
a keypad input feedback unit arranged to provide real time feed back to a user corresponding to a particular user supplied input command.

7. A personal multi-media device as recited in claim 1, wherein the display is selected from a group comprising: an LCD type display, an active matrix type display, and a plasma type display.

8. A personal multi-media device as recited in claim 1, further comprising:
a multi-media content data pack utility stored in the external processor used to create a formatted multi-media data pack for storage in the multi-media card as directed by the external processor.

9. A method of providing a personal multi-media device, comprising:
providing a controller portion having a host processor, a keypad connected to the host processor arranged to receive a user supplied command, and a display unit arranged to display an image, or a series of correlated images, derived from a multi-media content file stored in a multi-media card connected to the personal multi-media device; and
providing a cartridge portion connected to the controller portion by way of a multi-media content address/data bus having a slave processor arranged to decode the multi-media content file as directed by the host processor a mailbox coupling the slave processor to the host processor arranged as an addressable latch configured to provide an information channel between the host processor and the slave processor, and an I/O interface wherein when an external device coupled to the external interface includes an external controller, the external controller supercedes the host processor such that the external device is enabled to store selected multi-media content to the multi-media card.

10. A method as recited in claim 9, further comprising:
providing a memory unit arranged store a selected multi-media content file;
providing a multi-media interface configured to connect the multi-media card to the slave processor; and
providing a modem arranged to connect the slave processor to a distributed network of interconnected computers.

11. A method as recited in claim 9, wherein the multi-media content is stored on the multi-media card as a multi-media data packet, wherein the multi-media packet includes,
a header portion arranged to identify a multi-media file type associated with a particular multi-media file, and
a payload portion arranged to store the multi-media content corresponding to the associated multi-media type.

12. A method as recited in claim 11, further comprising:
providing a liner notes portion corresponding to the payload portion;
providing at least one advertising portion corresponding to the header portion arranged to provide an advertisement file; and
providing a cover graphics portion corresponding to the payload portion.

13. A method as recited in claim 12, further comprising a plurality of correlated graphics portions used to form a video stream that is displayed on the display unit.

14. A method of using a personal multi-media device having a host processor, a keypad connected to the host processor arranged to receive a user supplied command, and a display unit arranged to display an image, or a series of correlated images, derived from a multi-media content file stored in a multi-media card connected to the personal multi-media device and a multi-media content address/data bus connecting the host processor to a slave processor by way of a mailbox arranged to decode the multi-media content file as directed by the host processor, wherein the mailbox is arranged as an addressable latch configured to provide an information channel between the host processor and the slave processor, and an I/O interface wherein when an external device coupled to the external interface includes an external controller, the external controller supercedes the host processor such that the external device is enabled to store selected multi-media content to the multi-media card, comprising:
providing power to the PMD;
initializing the host processor and the slave processor as directed by the host processor;
determining if a multi-media card is connected to the PMD;
downloading a selected multi-media content file from the multi-media card based upon a user supplied selection command;
parsing the selected multi-media content file by the slave processor;
passing an image data file to the mailbox by the slave processor;
notifying the host processor that the mailbox has the image data file;
decoding an audio content file by the slave processor associated with the image data file; and
outputting substantially simultaneously the image data file by the host processor and the decoded audio content file by the slave processor.

15. A method as recited in claim 14, wherein when an external host having an external memory is connected to the PMD, then
superceding operation of the host processor by the external host processor;
formatting a multi-media data file stored in the external memory into a format consistent with the multi-media content file by the external processor;
transferring the external formatted multi-media content file from the external memory directly to the multi-media card by the slave processor; and
reliquishing control by the external host processor after the transferring is complete.
